(19) United States
(12) Patent Application Publication
(10) Pub. No.: US 2010/0044653 A1
(43) Pub. Date: Feb. 25, 2010

(54) COMPOSITION FOR TREATING FIBER MATERIALS

(76) Inventors: Salman Dermeik, Augusburg (DE); Karl-Heinz Lemmer, Augsburg (DE); Reinhold Braun, Schwabmunchen (DE)

Correspondence Address: HUNTSMAN TEXTILE EFFECTS ( GERMANY ) GMBH, LEGAL DEPARTMENT, 10003 WOODLOCH FOREST DRIVE, THE WOODLANDS, TX, 77380, US

(21) Appl. No.: 12/520,330

(22) PCT Filed: Dec. 18, 2007
(86) PCT No.: PCT/EP2007/011088

§ 371 Date: Jun. 19, 2009

(30) Foreign Application Priority Data
Dec. 20, 2006 (EP) 06026400

(51) Int. Cl. C09K 21/06

(52) U.S. Cl. 252/601

(57) ABSTRACT

Compositions comprising triesters of phosphoric acid and polyesters based on carboxylic acid and aromatics-free alcohol are useful for treating fiber materials. Flame-retardant properties are bestowed on the fiber materials, for example woven fabrics comprising polyester, by the treatment.

This invention relates to a composition for treating fiber materials, in particular textile fibers, yarns or fabrics. Flame-retardant properties are bestowed on fiber materials by treating with compositions that are in accordance with the present invention.

It is known to render textile fabrics composed of fiber materials or unsupported plastics film by treating with phosphorus compounds. This is apparent inter alia from U.S. Pat. No. 3,374,292, DE-A 25 09 592, and also from the abstracts of JP 2004-225 175 A2 and JP 2004-225 176 A2 in Chemical Abstracts (AN 141:175439 CA and AN 141:175 440 CA).

Prior art compositions used for rendering fiber materials flame-retardant have disadvantages. For instance, relatively high amounts of phosphorus compounds are frequently needed to achieve acceptable flame protection. This applies even when the fiber materials consist wholly or predominantly of polyester.

The present invention has for its object to provide a composition for providing a good flame-retardant finish to fiber materials consisting wholly or predominantly of polyester with just a lower add-on for the composition on the fiber materials than for existing finishes with phosphorus compounds. The present invention further has for its object to develop a process for treating fiber materials, in particular polyester fiber materials, which leads to good flame-retardant properties of the treated fiber materials.

We have found that this object is achieved by a composition comprising at least one

component A and at least one component B,
component A being a triester of phosphoric acid and
component B being a polyester comprising no aromatic radicals in the unit derived from the alcohol and comprising aromatic radicals in 0% to 10% of the units derived from the acid, and by a process for treating fiber materials which comprises applying a composition of the aforementioned kind to the fiber materials.

Good flame-retardant properties for fiber materials are obtainable by treating with compositions which are in accordance with the present invention. The fiber materials can be fibers or yarns; preferably, they are textile fabrics in the form of wovens or nonwovens. Compositions in accordance with the present invention provide good flame-retardant properties even to fiber materials consisting of polyester, in particular of polyethylene terephthalate or polybutylene terephthalate, to an extent in the range from 80% to 100% by weight. Treating such polyester materials constitutes a preferred use of compositions which are in accordance with the present invention. However, other fiber materials can be rendered flame-retardant as well, examples being fiber materials composed of wool or of fiber blends containing less than 80% by weight of polyester.

It is a particular advantage of compositions which are in accordance with the present invention that their use for treating fiber materials makes it possible to achieve good flame-retardant properties on the fiber material at a lower add-on level for phosphorus compounds than is customary in the prior art. This is evidently attributable to a positive synergistic effect between the two components (components A and B) of the compositions which are in accordance with the present invention, since the flame-retardant effect achievable is distinctly higher than from the use of component A alone or from component B alone. This positive synergistic effect is unexpected and surprising to a person skilled in the art, in particular because component B alone gives no flame-retardant effect at all.

It is a further advantage of compositions which are in accordance with the present invention that both component A and component B can be selected from halogen-free compounds and yet a good flame-retardant effect can be achieved. Prior art, halogen-containing compositions can give disadvantages by comparison which are known to one skilled in the art.

Compositions in accordance with the present invention comprise at least one component A and at least one component B. They may also comprise mixtures of compounds falling within the herein below stated definition of component A, and/or mixtures of compounds falling within the herein below stated definition of component B. They may additionally comprise further products falling neither within the definition of component A nor within the definition of component B. Such products include for example known softeners for textiles, surfactants, carriers, diffusion accelerants, and so on. Preferably, however, compositions in accordance with the present invention comprise no halogen compounds, nor preferably any polyesters other than those falling within the herein below stated definition of component B.

Component A in the compositions of the present invention is a triester of orthophosphoric acid. That is, all 3 hydroxyl groups of orthophosphoric acid O═P(OH)₃ are esterified with alcoholic compounds. These 3 alcohol units can be the same or different. Preferably, all 3 alcohol units are selected from monohydric or dihydric aromatic alcohols. Phenol and resorcinol are particularly useful as alcohol units of the phosphoric triester. In a particularly preferred embodiment of compositions according to the present invention, component A is a compound of the formula (I) or of the formula (II) or a mixture thereof:

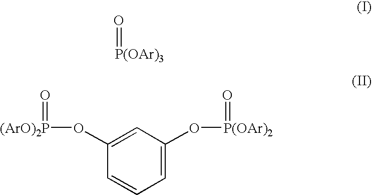

where Ar is a univalent aromatic radical, preferably phenyl.

The compound of the formula (II) where Ar is phenyl, hereinafter referred to as “RDP”, is commercially available and is obtainable as taught in U.S. Pat. No. 5,457,221.

In lieu of or in addition to the preferred triesters mentioned, which contain aromatic radicals, compositions in accordance with the present invention may also comprise triesters of orthophosphoric acid which contain no aromatic radicals. Tri-n-butyl phosphate is mentioned by way of example.

Component B in compositions according to the present invention is a polyester constructed of units derived from an acid and an alcohol. It is very important that the units derived from an alcohol do not contain any aromatic radicals. Otherwise, it is impossible to achieve good flame-retardant effects for finished textiles, and/or other disadvantages arise.

Preferably, the polyesters used as component B contain no aromatic radicals at all; that is, the unit derived from an acid is preferably also free of aromatic radicals. Unlike the alcohol unit, however, the acid unit may contain minor fractions of aromatic radicals. However, the fraction in the polyester of acid units comprising aromatic radicals must not exceed 10%, based on the total number of units derived from an acid.

In a particularly preferred embodiment of compositions in accordance with the present invention, component B is a polyester constructed from an aliphatic α, ω-dicarboxylic acid and an aliphatic dihydric or polyhydric alcohol, the dihydric or polyhydric alcohol preferably having a hydroxyl group attached at each of the two chain ends.

Aliphatic α, ω-dicarboxylic acids having 4 to 10 carbon atoms, especially unbranched dicarboxylic acids of the type mentioned, are very useful as acids in the context of the preferred embodiment mentioned here. Particularly good results can be obtained when the polyester used as component B is constructed from adipic acid and an alcohol.

The alcohol unit of the polyesters useful as component B is preferably derived from an aliphatic dihydric or polyhydric alcohol having a hydroxyl group at each of its two chain ends. The di- or polyhydric alcohol in question may have a branched or linear construction. Very useful alcohols for the polyesters include ethylene glycol, 1,3-propylene glycol, 1,4-butanediol, diethylene glycol, triethylene glycol, polyethylene glycol, neopentylglycol and 1,6-hexanediol.

The polyesters used as component B can be constructed, as stated, from a dicarboxylic acid and an aliphatic di- or polyhydric alcohol. Another possibility is to use polyesters derived from hydroxycarboxylic acids, preferably from ω-hydroxy 1-carboxylic acids, where the acid and alcohol units are present in the same molecule. The preparation of appropriate polyesters can proceed from the ω-hydroxy 1-carboxylic acid or from its lactone. Preference among polyesters mentioned is given to those which are derived from caprolactone.

The polyesters useful as component B can be constructed from a single kind of carboxylic acids and from a single kind of alcohol. However, they can also be constructed from a plurality of different kinds of carboxylic acids and/or kinds of alcohols. Preferably, all carboxylic acids used and all alcohols used are selected from the compound classes recited above. Polyesters derived from a mixture of caprolactone and polyhydric alcohol, for example neopentyl glycol, are also very useful as component B.

The molecular weight of the polyester used as component B is preferably in the range from 200 to 8000. Polyesters having a molecular weight in the range from 500 to 4000 are particularly useful.

The mixing ratio of component A to component B in compositions of the present invention can be varied within wide limits. To achieve good flame-retardant effects on finished fiber materials it is advantageous to select an A to B weight ratio in the range from 0.8:1 to 1.5:0.4 and preferably in the range from 1.2:1 to 1.5:0.5.

Compositions in accordance with the present invention can generally be produced in a simple manner by mixing the individual components, if appropriate at somewhat elevated temperature and/or with mechanical homogenization.

For some applications, it is advantageous to use compositions in accordance with the present invention in dissolved or dispersed form. Contemplated for this purpose are in particular either solutions in organic solvents or aqueous dispersions, and one or more dispersants can be used for dispersion in water. Useful dispersants are selectable from the products known to one skilled in the art in that, for example, nonionic ethoxylated compounds are suitable. Compositions according to the present invention may be applied in pure or dissolved or dispersed form to fiber materials by textile-finishing or -dyeing methods known to one skilled in the art. These include padding processes and exhaust processes. A particularly advantageous method of application, whereby a composition of the present invention and a dye are applied to the fiber materials in a single operation, is possible in many cases.

The amount applied to the fiber material of composition according to the present invention can be in the range known to a person skilled in the art of flame-retardant finishing. After application, the fiber materials can be dried under generally known conditions and, if appropriate, treated at further elevated temperature.

Examples follow to illustrate the present invention.

### EXAMPLE 1

A woven 100% polyethylene terephthalate fabric having a square meter weight of 310 g was subdivided into a plurality of samples which were each treated with one of the following solutions:

Series a) (Comparative Series) Not Inventive:

RDP (see formula II), above), solution of 2.5% to 6.0% by weight of RDP in methanol increasing in 0.5% steps (8 solutions).

The respective fabric was dipped into the appropriate solution and squeezed off to a wet pickup of about 100% by weight. This was followed by drying for 10 minutes at room temperature and then for 10 minutes at 110° C. with hot air. The samples were subjected to a DIN 54336 (November 1986 issue) burn test involving a flame being applied to an edge for 3 seconds. It was noted that only the samples from about 5% RDP add-on (amount of RDP on fabric in % by weight) upward had an after-burn time of 0 seconds, while the other samples did not pass the burn test.

Series b) (Inventive):

RDP and LUPRAPHEN® 1010 in 1:1 weight ratio in methanol from 4% to 12% increasing in 1% steps (8 solutions).

The respective fabric was dipped into the appropriate solution and squeezed off to a wet pickup of about 100% by weight. This was followed by drying for 10 minutes at room temperature and then for 10 minutes at 110° C. with hot air. The samples were subjected to a DIN 54336 burn test involving a flame being applied to an edge for 3 seconds. It was noted that all samples with just 2.5% RDP add-on upward had an after-burn time of 0 seconds, i.e., at a significantly lower phosphorus content than in the case of series a).

(LURAPHEN® 1010 is a difunctional aliphatic polyester polyol of molecular weight ˜1000 from the BASF Group)

### EXAMPLE 2

A 100% polyethylene terephthalate sample of tricot knit (about 200-205 g/m²) set at 180° 30″ without opt. brightener was subdivided into a plurality of samples which were each treated with one of the following solutions:

Series a) (Comparative Series) Not Inventive:

Solution of 2.5% to 6.0% by weight of RDP in methyl isobutyl ketone increasing in 0.5% steps (8 solutions).

The respective fabric was dipped into the appropriate solution and squeezed off to a wet pickup of about 100% by weight. This was followed by drying for 10 minutes at room temperature and then for 10 minutes at 110° C. with hot air. The samples were subjected to a DIN 54336 burn test involving a flame being applied to an edge for 3 seconds. It was noted that only the samples from about 4.5% RDP add-on upward had an after-burn time of 0 seconds.

Series b) (Inventive):

RDP and CAPA® 2200 in 0:7:0.3 weight ratio in methyl isobutyl ketone from 2.5% to 6.5% increasing in 1% steps (9 solutions).

The respective fabric was dipped into the appropriate solution and squeezed off to a wet pickup of about 100% by weight. This was followed by drying for 10 minutes at room temperature and then for 10 minutes at 110° C. with hot air. The samples were subjected to a DIN 54336 burn test involving a flame being applied to an edge for 3 seconds. It was noted that all samples with just 3% RDP add-on upward had an after-burn time of 0 seconds, i.e., there was no after-burn at a lower phosphorus content on the textile compared with series a).

CAPA® 2200 is a polymer (molecular weight ˜2000) based on caprolactone and neopentlyglycol from SOLVAY.

### EXAMPLE 3

A 100% polyethylene terephthalate sample of tricot knit (about 200-205 g/m²) set at 180° 30″ without opt. brightener was subdivided into two samples which were each treated with one of the following solutions:

a) Comparative Test (Not Inventive):

7 g of tributyl phosphate in 60 g of methyl isobutyl ketone.

The respective fabric was dipped into the appropriate solution and squeezed off to a wet pickup of about 100% by weight. This was followed by drying for 10 minutes at room temperature and then for 10 minutes at 110° C. with hot air. The samples were subjected to a DIN 54336 burn test involving a flame being applied to an edge for 3 seconds. It was noted that the sample did not pass the burn test; i.e., the flame did not extinguish.

b) (Inventive):

7 g of tributyl phosphate and 3 g of CAPA® 2200 in 60 g of methyl isobutyl ketone.

The respective fabric was dipped into the appropriate solution and squeezed off to a wet pickup of about 100% by weight. This was followed by drying for 10 minutes at room temperature and then for 10 minutes at 110° C. with hot air. The samples were subjected to a DIN 54336 burn test involving a flame being applied to an edge for 3 seconds. It was noted that this sample has an after-burn time of 0 seconds, i.e., passed the burn test.

1. A composition comprising at least one component A and at least one component B, component A being a triester of phosphoric acid and component B being a polyester comprising no aromatic radicals in the unit derived from the alcohol and comprising aromatic radicals in 0% to 10% of the units derived from the acid.

2. The composition according to claim 1 wherein component A is a triester constructed of units derived from phosphoric acid and units derived from mono- or dihydric aromatic alcohols.

3. The composition according to claim 1 wherein component A is a compound of the formula (I) or of the formula (II) or a mixture thereof: 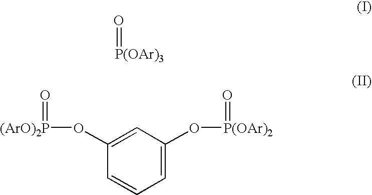
where Ar is a univalent aromatic radical.

4. The composition according to claim 1 wherein component B is a polyester constructed from an aliphatic α, ω-dicarboxylic acid and an aliphatic dihydric or polyhydric alcohol.

5. The composition according to claim 4 wherein the aliphatic dicarboxylic acid has 4 to 10 carbon atoms.

6. The composition according to claim 5 wherein the dicarboxylic acid is adipic acid.

7. The composition according to claim 4 wherein the aliphatic alcohol is selected from ethylene glycol, 1,3-propylene glycol, 1,4-butanediol, diethylene glycol, triethylene glycol, polyethylene glycol, neopentylglycol and 1,6-hexanediol.

8. The composition according to claim 1 wherein component B is a polyester derived from an ω-hydroxy 1-carboxylic acid or its lactone.

9. The composition according to claim 1 wherein component B has a molecular weight in the range from 200 to 8000.

10. The composition according to claim 1 wherein the weight ratio of component A to component B is in the range from 0.8:1 to 1.5:0.4.

11. A process for treating a fiber material, which comprises applying a composition according to claim 1 to the fiber material.

12. The process according to claim 11 wherein the fiber material consists of polyester to an extent in the range from 80% to 100% by weight.

13. The composition according to claim 3 wherein Ar is phenyl.

14. The composition according to claim 4 wherein the dihydric or polyhydric alcohol has a hydroxyl group attached at each of the two chain ends.

15. The composition according to claim 8 wherein component B is a polyester derived from caprolactone.

16. The composition according to claim 9 wherein component B has a molecular weight in the range from 500 to 4000.

17. The composition according to claim 1 wherein the weight ratio of component A to component B is in a range from 1.2:1 to 1.5:0.5.
